(19) United States
(12) Patent Application Publication
(10) Pub. No.: US 2015/0147239 A1
(43) Pub. Date: May 28, 2015

(54) ZPGM Underfloor Catalyst for Hybrid Exhaust Treatment Systems

(71) Applicants: Maxime Launois, Massy (FR); Randal L. Hatfield, Port Hueneme, CA (US)

(72) Inventors: Maxime Launois, Massy (FR); Randal L. Hatfield, Port Hueneme, CA (US)

(73) Assignee: CLEAN DIESEL TECHNOLOGIES INC. (CDTI), Ventura, CA (US)

(21) Appl. No.: 14/090,821

(22) Filed: Nov. 26, 2013

(51) Int. Cl. B01D 53/94

(52) U.S. Cl. CPC B01D 53/94
USPC 422/180

(57) ABSTRACT

Hybrid PGM-ZPGM exhaust treatment systems are disclosed. The systems include a PGM close-couple catalytic converter followed by an underfloor ZPGM catalytic converter. The disclosed hybrid systems, including PGM based catalysts and zero-PGM based catalysts may replace pure PGM based exhaust treatment systems. The ZPGM catalyst compositions used may include copper and cerium as active ZPGM catalysts. The disclosed ZPGM underfloor converters may be designed to convert leaks from close-couple converters.

### CROSS-REFERENCE TO RELATED APPLICATIONS

N/A

### BACKGROUND

1. Field of the Disclosure

The present disclosure relates in general to exhaust treatment systems, and more specifically to hybrid PGM-ZPGM exhaust treatment systems.

2. Background Information

Emission standards for unburned contaminants, such as hydrocarbons, carbon monoxide and nitrogen oxide, continue to become more stringent. In order to meet such standards, three-way catalysts (TWC) are used in the exhaust gas lines of internal combustion engines. These catalysts promote the oxidation of unburned hydrocarbons and carbon monoxide as well as the reduction of nitrogen oxides in the exhaust gas stream. One of the major limitations of current three-way catalysts is that the Platinum Group Metals (PGM), like platinum, palladium, and rhodium have been used extensively for reducing the emissions from gasoline based engines as the active components of TWC converters. PGMs are in limited supply due to a low natural abundance in the earth's crust. Commercial concentrations of these elements are concentrated in a few countries, which make the supply for these metals sensitive to political, trade, and labor based disruptions.

Therefore, there is a continuing need to provide cost effective three way catalyst systems that provide sufficient conversion so that HC, NOx, and CO emission standards can be satisfied, minimizing the amount of PGM catalysts required.

### SUMMARY

Hybrid TWC converter systems are disclosed. The TWC converter systems may include a close-couple converter, and an underfloor converter in series. Close-couple converters may be attached to the exhaust manifold of gasoline engines and may include PGM based catalyst compositions, generally these converters may be designed to be constantly exposed to high temperatures. In some embodiments, the underfloor converter may include only ZPGM based TWC compositions.

The ZPGM catalyst system of underfloor converter may include a substrate, a washcoat and an overcoat.

Suitable materials for use as substrates may include refractive materials, ceramic materials, metallic alloys, foams, microporous materials, zeolites, cordierites, or combinations.

Washcoat or overcoat, or both, may include at least one ZPGM catalyst, carrier material oxides and oxygen storage materials (OSMs). Suitable known in the art chemical techniques, deposition methods and treatment systems may be employed in order to form the disclosed ZPGM catalyst converters.

The disclosed systems may allow a reduction of the amount of PGMs needed to satisfy emissions standards. Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a hybrid exhaust treatment system, according to an embodiment.

FIG. 2 shows a ZPGM catalyst system structure, according to an embodiment.

FIG. 3 is a flowchart of a method of preparation of a ZPGM catalyst, according to an embodiment.

FIG. 4 shows light-off test results of hybrid and PGM only exhaust systems, according to an embodiment.

FIG. 5 show test results for THC conversion using hybrid and PGM only exhaust systems, according to an embodiment.

FIG. 6 show test results for THC conversion using hybrid and PGM only exhaust systems, according to an embodiment.

FIG. 7 show test results for NOx conversion using hybrid and PGM only exhaust systems, according to an embodiment.

FIG. 8 shows a comparison of richness in exhaust gases for hybrid and PGM only exhaust systems, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Conversion” refers to the chemical alteration of at least one material into one or more other materials.

“Three Way Catalyst (TWC)” refers to a catalyst suitable for use in converting at least hydrocarbons, nitrogen oxide, and carbon monoxide.

“Zero Platinum Group (ZPGM) Catalyst” refers to a catalyst completely or substantially free of platinum group metals.

“Platinum Group Metals (PGMs)” refers to platinum, palladium, ruthenium, iridium, osmium, and rhodium.

“R Value” refers to the number obtained by dividing the reducing potential by the oxidizing potential.

“Rich Exhaust” refers to exhaust with an R value above 1.

“Lean Exhaust” refers to exhaust with an R value below 1.

“Front Catalyst” refers to catalysts that may be exposed to high temperatures due to their proximity to an engine's exhaust manifold.

“Under Floor Catalyst” refers to catalysts that may be placed after a Front Catalyst, and exposed to lower temperatures due to the distance to an engine's exhaust manifold.

“Front Catalyst Leak” may refer to a portion of the gases present in an exhaust stream not being converted into less harmful species.

### Description Of The Drawings

The present disclosure describes hybrid PGM/ZPGM exhaust treatment systems that may be capable reducing the amounts PGMs needed to comply with emissions standards by replacing PGM underfloor catalysts with ZPGM based catalysts.

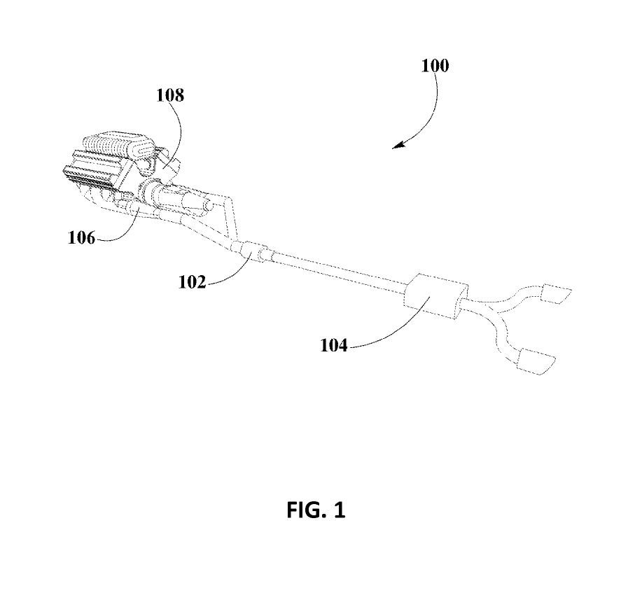

FIG. 1 shows TWC converter system 100, according to an embodiment. TWC converter system 100 includes a close-couple converter 102, and a second converter in series, an underfloor converter 104. Close-couple converter 102 may be attached to exhaust manifold 106 of gasoline engine 108 may include PGM based catalyst compositions and it may be designed to be constantly exposed to high temperatures. In some embodiments, close-couple converter 102 may be exposed to temperatures up to 800 or 1100° C. Underfloor converter 104 may be generally positioned under the floor of the passenger compartment of the vehicle and may be exposed to lower temperatures, compared to close-couple converter 102. In some embodiments, underfloor converter 104 may include only ZPGM based TWC compositions.

In some embodiments, close-couple converter 102 may be designed as a small catalyst for fast light off and may not big enough to convert pollutants during cycles where the space velocity is too high. In these embodiments, underfloor converters 104 may be used to clean up the exhaust gases during this phase.

The bed-volume between the close-couple converter 102 and underfloor converter 104 may vary and may be optimized according to each particular application. In some embodiments, close-couple converter 102 and underfloor converter 104 may be aligned in a single same canning.

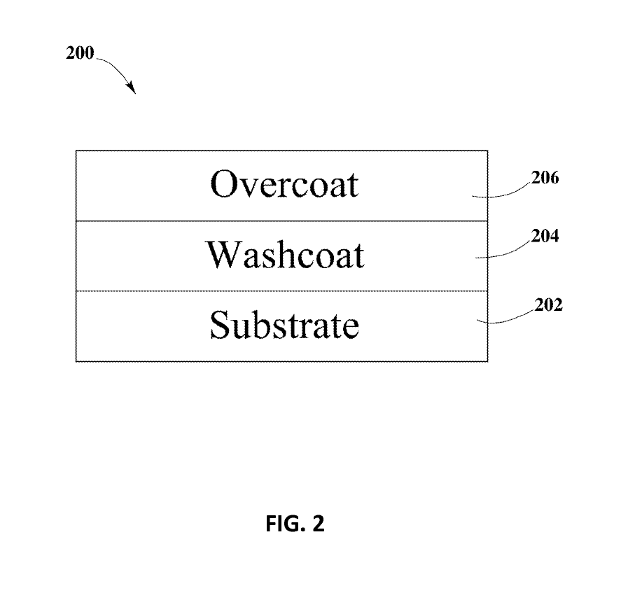

FIG. 2 depicts ZPGM catalyst system 200 configuration, according an embodiment. As shown in FIG. 2, ZPGM catalyst system 200 may include at least a substrate 202 a washcoat 204 and an overcoat 206, where washcoat 204 or overcoat 206, or both, may include active three way ZPGM catalyst components.

According to an embodiment, washcoat 204 or overcoat 206 or both may include at least one ZPGM transition metal catalyst, a ZPGM mixed metal catalyst, a ZPGM zeolite catalyst, or combinations thereof. A ZPGM transition metal catalyst may include one or more transition metals and/or least one rare earth metal, or a mixture; excluding platinum group metals.

Suitable materials for use as substrates 202 may include refractive materials, ceramic materials, metallic alloys, foams, microporous materials, zeolites, cordierites, or combinations.

According to an embodiment, washcoat 204 may include an oxygen storage materials and carrier material oxides. Overcoat 206 includes copper oxide, ceria, alumina, and at least one oxygen storage material. Oxygen storage materials (OSMs) may include cerium, zirconium, lanthanum, yttrium, lanthanides, actinides, and mixtures thereof. Carrier material oxides may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. In some embodiments, carrier material oxides may be doped with one or more lanthanides.

The oxygen storage material and the alumina may be present in washcoat 204 in a ratio between 40% and about 60% by weight. The alumina and oxygen storage material included in overcoat 206 are present in a ratio of about 60% to about 40% by weight. The copper and cerium in overcoat 206 are present in about 5% to about 50% by weight or from about 10% to 16% by weight of Cu and 12% to 20% by weight of Ce.

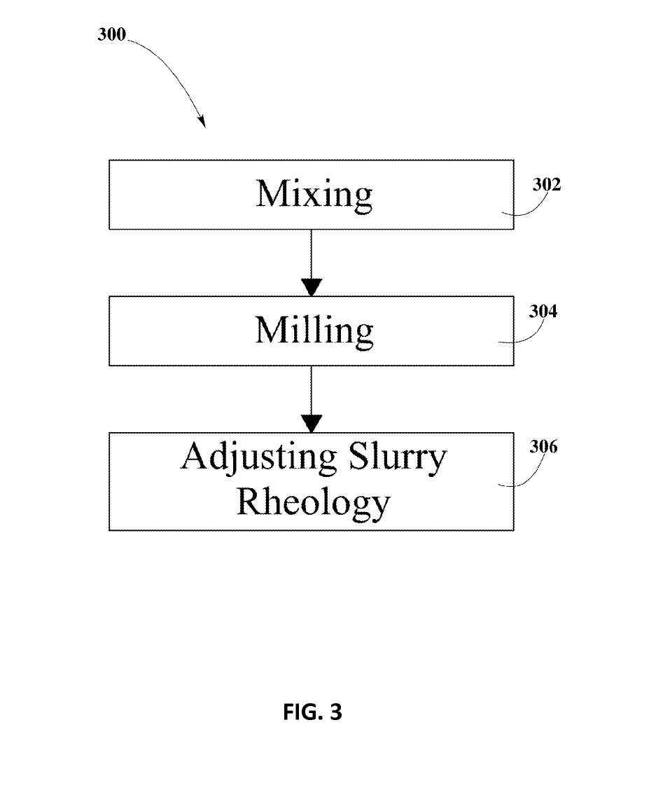

FIG. 3 is a flowchart of method for preparation 300 of washcoat 204 and overcoat 206, according to an embodiment. Washcoat 204 or overcoat 206 may be prepared by following method for preparation 300. In an embodiment, method for preparation 300 may be a “co-milling method” which may begin with a mixing 302 process. In this process, components of washcoat 204 or overcoat 206, previously described, may be mixed together. Subsequently, the mixture may undergo a milling process 304 in which washcoat 204 or overcoat 206 materials may be broken down into smaller particle sizes. After milling process 304, a catalyst aqueous slurry may be obtained. Milling process 304 may take from about 10 minutes to about 10 hours, depending on the batch size, kind of material and particle size desired. In one embodiment of the present disclosure, suitable average particle size (APSs) of the slurry may be of about 4 microns to about 10 microns, in order to get uniform distribution of washcoat 204 particles or overcoat 206 particles. Finer particles may have more coat ability and better adhesion to substrate 202 and enhanced cohesion between washcoat 204 and overcoat 206 layers. Milling process 304 may be achieved by employing any suitable mill such as vertical or horizontal mills. In order to measure exact particle size desired during milling process 304, a laser light diffraction equipment may be employed. In order to further enhance coatability and binding properties of washcoat 204 and overcoat 206, aqueous slurries obtained in milling process 304 may undergo an adjusting rheology 306 step. In adjusting rheology 306 step, acid or base solutions or various salts or organic compounds may be added to the aqueous slurries. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol and other suitable compounds. Afterwards, the catalyst composition may be coated onto a suitable substrate 202 and then heat treated. This treatment may be performed at about 300° C. to about 700° C. In some embodiments this treatment may be performed at about 550° C. The heat treatment may last from about 2 to about 6 hours.

In an embodiment the treatment may last about 4 hour.

In other embodiments, washcoat 204 and overcoat 206 may be synthesized by any chemical techniques known in the art.

### EXAMPLES

In Example #1 a hybrid catalyst exhaust treatment system and a PGM-only catalyst exhaust treatment system are compared. The systems are compared using the standard New European Driving Cycle (NEDC). This test includes four urban driving cycles (ECE) and one extra urban driving cycle (EU DC).

For both systems the front brick (close-couple converter) is the same, has a small volume for reduced thermal inertia and for a rapid catalyst temperature increase, which allows emissions conversion as soon as the catalyst is hot enough. The close couple converter used is a (0/90/7) Palladium-Rhodium converter with a volume of 0.4 L

Rear brick has a bigger substrate volume but reduced PGM load. This catalyst is used to convert front brick leakage. In both systems the underfloor converter has a volume of 1.2 L.

The PGM only exhaust treatment system includes a palladium only (0/65/0) underfloor converter.

The hybrid exhaust treatment system includes a ZPGM catalyst system similar to the one described in FIG. 2. The catalyst system includes a ZPGM transition metal catalyst having a cordierite substrate, a washcoat and an overcoat. The washcoat includes an oxygen storage material (which may be a mixture of cerium and zirconium) and alumina. Overcoat includes copper oxide, ceria, alumina, and at least one oxygen storage material. The oxygen storage material is a mixture of cerium, zirconium, neodymium, and praseodymium. The oxygen storage material and the alumina may be present in washcoat in a ratio between 40% and about 60% by weight. The alumina and oxygen storage material included in overcoat are present in a ratio of about 60% to about 40% by weight. The copper and cerium in overcoat are present in about 5% to about 50% by weight or from about 10% to 16% by weight of Cu and 12% to 20% by weight of Ce.

The PGM and ZPGM converters of both exhaust treatment systems have been aged at a certified OEM engine aging center to represent 60 000 km. This aging may be hard enough to discriminate catalyst performances. The catalyst evaluation is completed on a Renault K4M Flex fuel engine (1.6L, 16V) equipped with a fast cooling capability. The simulation is done and correlated with K4M Grand Scenic vehicle on NEDC cycle.

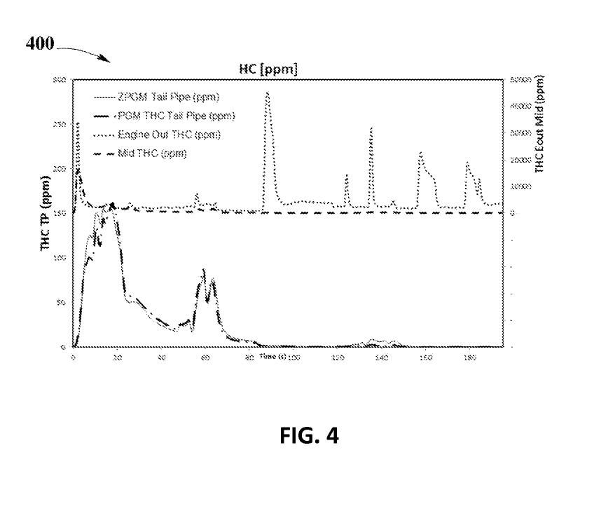

FIGS. 4 to 8 show the results of the tests performed as part following the procedures of example #1.

FIG. 4 shows light-off test results 400 of hybrid and PGM only exhaust systems of example #1, according to an embodiment. The behavior of both systems during cold start (20° C.) at ECE 1 part of the cycle is reflected in FIG. 4, in terms of THC conversion. As it can be appreciated in FIG. 4, in this part of the cycle there is no significant difference in the conversion potential of both systems.

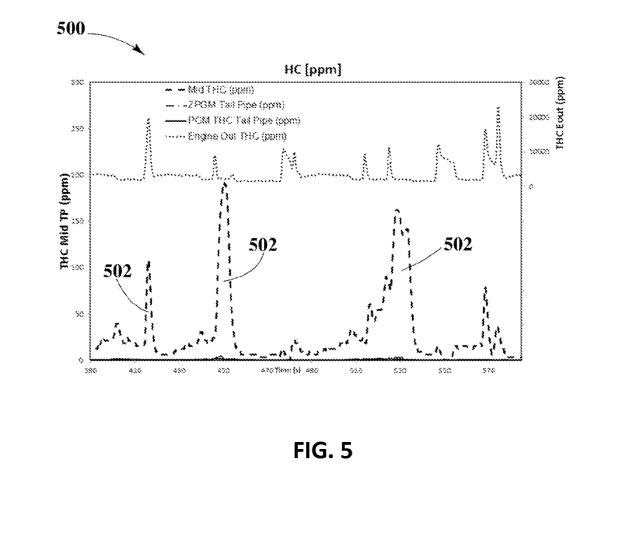

FIG. 5 shows test results 500 for THC conversion using hybrid and PGM only exhaust systems of example #1, according to an embodiment. The behavior of both systems during ECE 3 part of the cycle is reflected in FIG. 5, in terms of THC conversion. At this point in the cycle, both converters are hot and are able to convert the THC leaks 502 from the close-couple converters. As it can be appreciated in FIG. 5, in this part of the cycle there is no significant difference in the conversion potential of both systems.

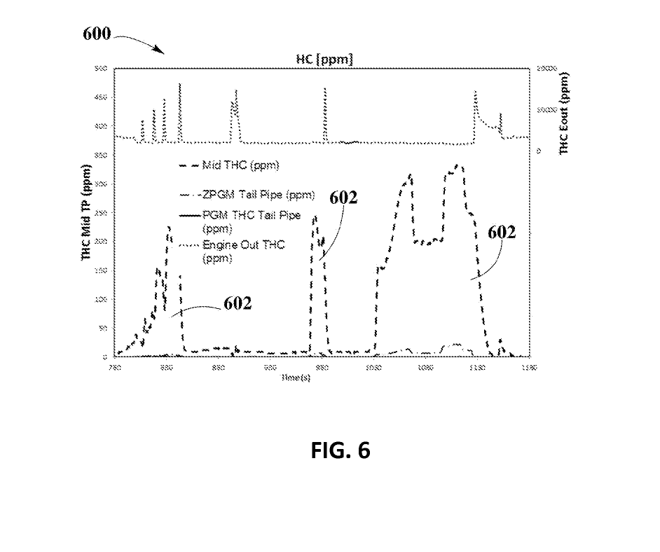

FIG. 6 shows test results 600 for THC conversion using hybrid and PGM only exhaust systems of example #1, according to an embodiment. The behavior of both systems during EUDC part of the cycle is reflected in FIG. 6, in terms of THC conversion. At this point in the cycle, both underfloor converters are hot and are able to convert the THC leaks 602 from the close-couple converters. As it can be appreciated in FIG. 6, in this part of the cycle there is no significant difference in the conversion potential of both systems.

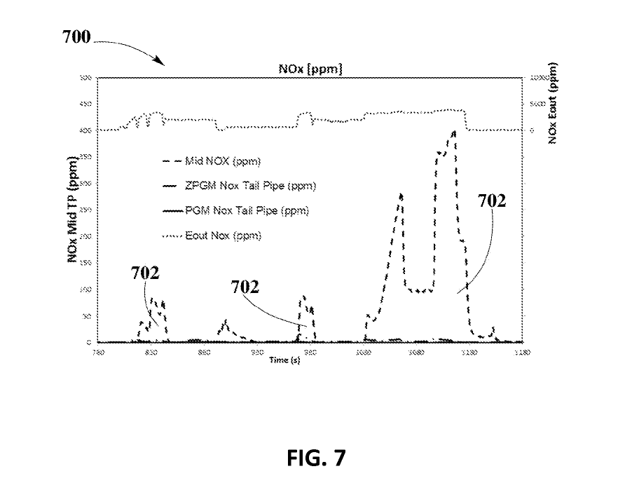

FIG. 7 shows test results 700 for NOx conversion using hybrid and PGM only exhaust systems of example #1, according to an embodiment. The behavior of both systems during EUDC part of the cycle is reflected in FIG. 7, in terms of NOx conversion. At this point in the cycle, both underfloor converters are hot and are able to convert the NOX leaks 702 from the close-couple converters, leaks 702 may be caused by the high space velocity or poor engine Air/Fuel control, or over emission of NOx in the exhaust system during the EUDC part of the cycle. As it can be appreciated in FIG. 7, in this part of the cycle there is no significant difference in the conversion potential of both systems.

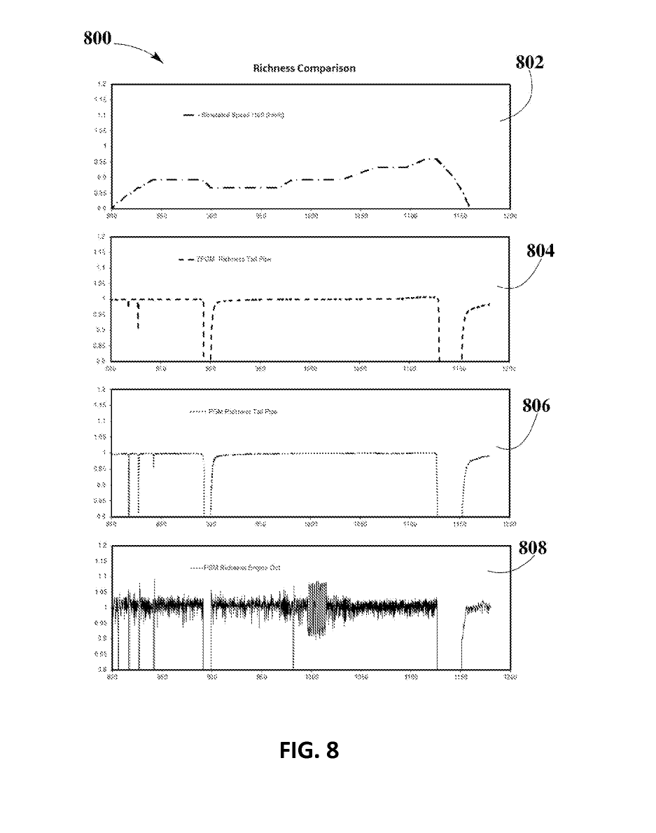

FIG. 8 shows a graph 800 comparison of richness in exhaust gases for hybrid and PGM only exhaust treatment systems of example #1, according to an embodiment. The behavior of both systems during the EUDC part of the cycle is reflected in FIG. 8. Graph 802 shows the simulated speed during the cycle. Graph 804 shows the richness of the exhaust gases exiting the hybrid exhaust treatment system. Graph 806 shows the richness of the exhaust gases exiting the PGM-only exhaust treatment system. Graph 808 shows the richness of the exhaust gases exiting the engine. As it can be appreciated in FIG. 8, there is no significant difference in the oxygen storage capacity of the exhaust treatment systems of example #1.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A catalyst system for use during an urban drive cycle, the catalyst system comprising:
at least one close-couple converter; and
at least one underfloor converter;
wherein the underfloor converter comprises a zero platinum group metal (ZPGM) catalyst system, comprising:
a substrate;
a washcoat suitable for deposition on the substrate, comprising at least one first oxygen storage material and alumina; and
an overcoat suitable for deposition on the substrate, comprising at least one second oxygen storage material and one selected from the group comprising copper oxide, ceria, alumina, and mixtures thereof.

2. The catalyst system of claim 1, wherein the at least one first oxygen storage material comprises at least one selected from the group consisting of cerium, zirconium, and mixtures thereof.

3. The catalyst system of claim 1, wherein the ratio of the at least one first oxygen storage material to alumina in the washcoat is 60:40.

4. The catalyst system of claim 1, wherein the at least one second oxygen storage material comprises at least one selected from the group consisting of cerium, zirconium, and mixtures thereof.

5. The catalyst system of claim 1, wherein the ratio of the at least one first oxygen storage material to alumina in the overcoat is 60:40.

6. The catalyst system of claim 1, wherein the substrate is metallic.

7. The catalyst system of claim 1, wherein the first oxygen storage material comprises cerium, zirconium, lanthanum, yttrium, lanthanides, actinides, and mixtures thereof.

8. The catalyst system of claim 1, wherein the second oxygen storage material comprises cerium, zirconium, lanthanum, yttrium, lanthanides, actinides, and mixtures thereof.

9. The catalyst system of claim 1, wherein the conversion of HC is at substantially the same rate as for a catalyst system containing platinum group metals.

10. The catalyst system of claim 1, wherein the conversion of NoxC is at substantially the same rate as for a catalyst system containing platinum group metals.

11. The catalyst system of claim 1, wherein the conversion of HC is at substantially the same rate as for a catalyst system containing platinum group metals when under Extra Urban Driving Cycle conditions.

12. The catalyst system of claim 1, wherein the conversion of NOx is at substantially the same rate as for a catalyst system containing platinum group metals when under Extra Urban Driving Cycle conditions.

13. The catalyst system of claim 1, wherein the close-couple converter is proximate to an exhaust manifold.

14. The catalyst system of claim 1, wherein the at least one underfloor converter effectively converts at least a portion of unconverted exhaust from the at least one close-couple converter.
